(19) United States
(12) Patent Application Publication
(10) Pub. No.: US 2005/0086465 A1
(43) Pub. Date: Apr. 21, 2005

(54) System and method for protecting network management frames

(75) Inventors: Bhawani Sapkota, Fremont, CA (US); Nancy Cam Winget, Mountain View, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Cisco Technology, Inc., San Jose, CA (US)

(21) Appl. No.: 10/687,075

(22) Filed: Oct. 16, 2003

(51) Int. Cl. H04L 9/00

(52) U.S. Cl. 713/150

(57) ABSTRACT

System architecture and corresponding method for securing the transmission of management frame packets on a network (e.g. IEEE 802.11) is provided. Once a trust relationship is created between a transmitter and a receiver on the network such that the transmitter is authorized to communicate over the network, a key and corresponding message integrity check may be generated in order to sign management frame communications via the network. The message integrity check and a replay protection value may be transmitted with the management frame packet. Upon receipt, the message integrity check and replay protection value are authenticated to verify permitted transmission of the management frame packet.

### BACKGROUND OF THE INVENTION

The IEEE (Institute of Electrical and Electronic Engineers) 802.11 standard provides guidelines for allowing users to wirelessly connect to a network and access basic services provided therein. It has become more evident in recent years that security and controlled access are necessities in light of the large amount of sensitive information that is communicated over networks today.

Traditionally, the security and controlled access efforts have been directed toward protecting the data content of the transmission and not toward the prevention of session disruption. In other words, prior efforts have only been directed toward protecting the sensitivity of the content of the data transmitted and not toward the protection of the transmission of management frame packets which control the session integrity and quality.

Of course, access to a network can be restricted by any number of methods, including user logins and passwords, network identification of a unique identification number embedded within the network interface card, call-back schemes for dial-up access, and others. These conventional protection schemes are directed toward controlling the overall access to the network services and toward protecting the data transmissions.

Unfortunately, identifying information contained within the management frames transmitted via a network (e.g. IEEE 802.11 network) has not been the focus of protection in traditional security schemes. This lack of protection leaves the network vulnerable to attackers whereby an attacker can spoof a MAC address thereby impersonating valid stations. For example, such attacks can lead to session interruption by an imposter posing as a valid user sending a disassociation request subsequently disrupting the trusted user's session.

Additionally, a network session may also be crippled if an action management frame is impersonated thereby affecting the quality of service as well as other capabilities.

What is needed is to provide more extensive control between wireless entities such that the trust relationship includes the authentication of management frame data packets transmitted via the network.

### SUMMARY OF THE INVENTION

The present invention disclosed and claimed herein, in one aspect thereof, comprises architecture for securing management frames and/or preventing session disruption on a network (e.g. IEEE wireless 802.11). A trust relationship is created between a transmitter and a receiver on the network such that the transmitter is authorized to communicate over the network.

Next, a key is generated for deriving an information element that may be used for signing a management frame packet transmitted on the network. Once the information element is derived, the information element may be embedded into the management frame packet and transmitted to the receiver on the network. Upon receipt, the receiver may be suitably configured to validate the information element included within the management frame packet.

In one embodiment, the information element includes a message integrity check information element. In another embodiment, the information element may additionally include a replay protection value. In the latter, the system and method provide for the generation of the replay protection value for signing the management frame packet. This replay protection value may be added into the management frame packet (e.g. information element) prior to transmission via the network and validated upon receipt.

In yet another embodiment, the present system and method provides for the local generation of an information element to be compared to the received information element in the validation process. Additionally, a local message integrity check and replay protection value may be generated to facilitate the validation process.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

For a more complete understanding of the present system and the advantages thereof, reference is now made to the following description taken in conjunction with the accompanying drawings in which:

FIG. 1 illustrates a network block diagram that operates to control network access of wireless clients, in accordance with a disclosed embodiment; and

FIG. 2 illustrates a flow chart of the information exchange between the various entities for authenticating and validating the transmission of management frame data, in accordance with a disclosed embodiment.

### DETAILED DESCRIPTION OF THE INVENTION

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or cartridge, a carrier wave/pulse, or any other medium from which a computer, a processor or other electronic device can read. Signals used to propagate instructions or other software over a network, such as the Internet, are also considered a “computer-readable medium.”

“Internet”, as used herein, includes a wide area data communications network, typically accessible by any user having appropriate software.

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like. Logic may also be fully embodied as software.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

The following includes examples of various embodiments and/or forms of components that fall within the scope of the present system that may be used for implementation. Of course, the examples are not intended to be limiting and other embodiments may be implemented without departing from the spirit and scope of the invention.

The IEEE (Institute of Electrical and Electronic Engineers 802.11 standard provides guidelines for allowing users to wirelessly connect to a network and access basic services provided therein. The content of the IEEE 802.11 specification standard and the 802.11i pre-standard is hereby incorporated into this specification by reference in its entirety.

Although the embodiments of present system and method described herein are directed toward an IEEE 802.11 wireless network, it will be appreciated by one skilled in the art that the present concepts and innovations described herein may be applied to alternate wired and wireless network protocols without departing from the spirit and scope of the present innovation.

Briefly describing one embodiment of the present system, it provides for a network suitably configured to authenticate and protect the transmission of management frames in a wireless network thereby potentially preventing session disruption. Specifically, one embodiment of the present innovation is directed toward a system and method configured to establish unique keys in order to protect the security of management frames transmitted in an 802.11 authenticated network session.

In other words, the system may be configured to establish a secure key corresponding to management frame transmission. This secure key may be suitably configured to enable the computation of a message integrity check (MIC) used to authenticate 802.11 management frames. In accordance with the present system and method, it will be appreciated that the key may be established in the same manner as the keys derived to protect data packets or 802.1x EAPOL key messages are presently handled in accordance with the IEEE 802.11i pre-standard.

The disclosed system and method set forth infers protection of management frames over an 802.11 network following the establishment of trusted relationships between an authenticator and a number of supplicants or clients. The following embodiments will be described directed toward an access point (AP) as the authenticator and the wireless clients (PCs) as the supplicants. As well, the following embodiments will be directed toward an AP as a receiver and a wireless client as a transmitter of a management frame packet.

Of course, alternate embodiments of the present system and method may be configured utilizing other authenticator and supplicant components. For example, it will be appreciated that the authenticator may be an access point, switch, authentication server or the like. As well, it will be appreciated that a supplicant may be any device capable of transmitting and receiving data packets via an 802.11 wireless network such as a personal data assistant (PDA), digital phone, electronic tablet, or the like.

In accordance with an embodiment of the present system and method, upon establishment of the trust relationship between an AP and corresponding wireless clients, the wireless clients are recognized as trusted wireless clients and accordingly are able to access the services of the network. Therefore, as a result of the trusted relationship, information may be securely communicated between the wireless clients and the AP.

As previously stated, one embodiment of the present system and method is directed toward establishing a unique key to be used in computing a MIC to validate the transmission and reception of management frame packets via a wireless network. For example, if the receiver receives a management frame packet with an incorrect MIC, the receiver would discard the received packet and ignore the information contained therein.

It will be appreciated that additional and/or alternate management frame protection methods may be used in accordance with the present system and method. For example, in accordance with an embodiment, the present system and method may be suitably configured to generate a sequential replay protection counter to assist in verification of management frame packets. In a preferred embodiment, this replay protection value may be used in conjunction with the MIC value previously described.

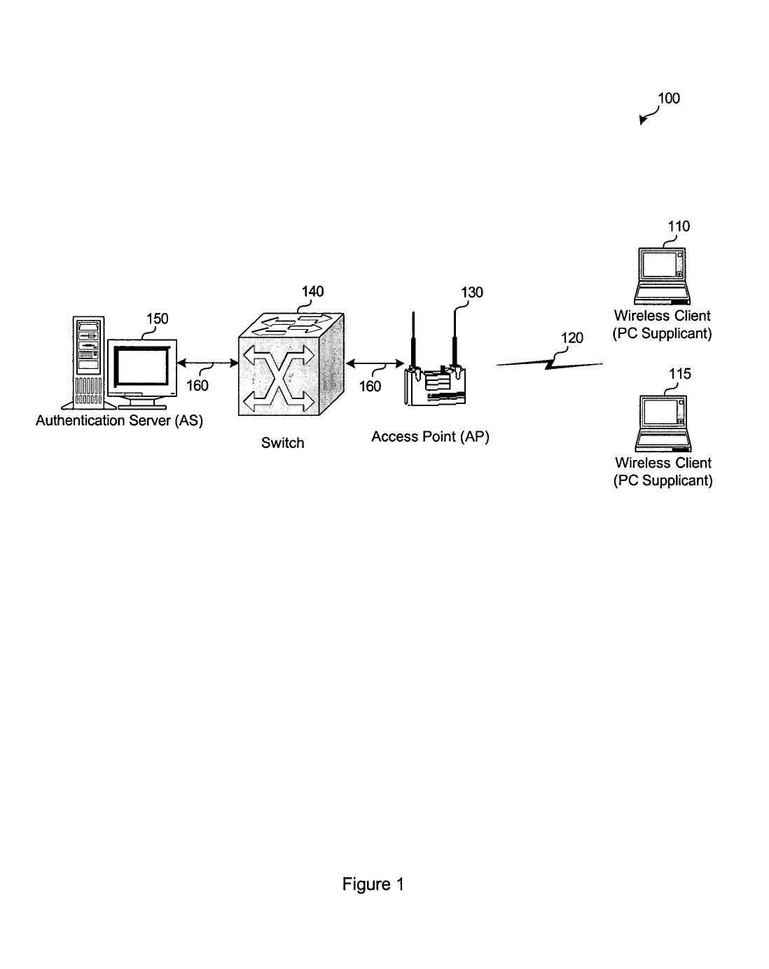

Illustrated in FIG. 1 is a simplified system component diagram of one embodiment of the present system 100. The system components shown in FIG. 1 generally represent the system 100 and may have any desired configuration included within any system architecture.

Following is a general description a wireless network architecture in accordance with one embodiment of the present system. The architecture is described generally in order to disclose the manner in which a key may be generated and applied to provide management frame protection and security.

Referring now to FIG. 1 an embodiment of the system generally includes wireless clients 110, 115 suitably configured and operatively connected to access services on a wireless network 120 via an AP 130. It will be appreciated that the wireless clients 110, 115 may be any component capable of transmitting via a wireless network such as a laptop/notebook portable computer having Cardbus network adapter suitable for wireless communication with a wired network, an electronic tablet having a suitable wireless network adapter, a handheld device containing a suitable wireless network adapter for communicating to a wired network or the like.

As illustrated in FIG. 1, an AP 130 may be configured to provide the communicative transition point between the dedicated wired network 160 and the wireless clients (or supplicants) 110, 115. Additionally, a basic wireless network (e.g. IEEE 802.1 1) implementation may include a switch 140 suitably configured to operate to provide interconnectivity between a plurality of network devices disposed on the wired network 160 and optionally between a plurality of networks (not shown).

An authentication server (AS) 150 may be disposed on the wired network 160 suitably configured to provide authentication services to those network entities requiring such a service. Of course, it will be appreciated that the AS 150 and corresponding functionality may be employed as a stand alone component or combined within another existing component. In other words, the functionality of the AS 150 may be included within the switch 140 or the AP 130.

In one embodiment, the AS 150 provides the authentication and authorization services to any network entity that functions as an authenticator. A network entity can take the role of an authenticator when that entity performs authentication in conjunction with the AS 150 on behalf of another entity requesting access to the network.

For example, the authentication server determines, from credentials provided by the wireless clients 110, 115, whether the wireless clients 110, 115 are authorized to access the services controlled by the authenticator (e.g. switch 140, or AP 130). It will be appreciated that the AS 150 can be co-located with an authenticator, or it can be accessed remotely via a network to which the authenticator has access. Additionally, the network 160 can be a global communication network, e.g., the Internet, such that authentication occurs over great distances from a remote location disposed thereon to the AS 150.

In one embodiment, component authentication may occur upon system initialization. Alternatively, component authentication may occur when a supplicant (e.g. wireless client 110, 115) requests connection to a port of an authenticator system or when authorized access has become unauthorized, and subsequently requested to be reauthorized.

In accordance with the present system and method, the wireless clients 110, 115 may be configured to authenticate to the AS 150 utilizing any one of a number of conventional authentication algorithms known in the art. For example, the present system and method may be configured to utilize authentication algorithms such as EAP-Cisco Wireless, a certificate-based scheme such as EAP-TLS or the like.

In operation, the trust relationship is established with the wireless clients 110, 115 in the following manner. Once the dedicated network 160 is operational and the wired entities (130, 140, 150) have established proper connectivity, authentication of the wireless clients 110, 115 is commenced.

The wireless clients 110, 115, using conventional protocols, may communicate a connection request via a communication link 120 to the AP 130, and which AP 130 now takes on an authenticator role. The AP 130 processes the connection request message by sending the wireless client 110, 115 authentication request to the AS 150.

The packet information may be sent to the switch 140 such that the switch 140 recognizes the traffic as coming only from the AP 130. Because the switch 140 then recognizes the traffic as coming from the authorized AP 130, the packet is passed through to the AS 150 for authentication.

Until such authorization of the wireless clients 110, 115 occurs, the AP 150 restricts any uncontrolled traffic of the wireless clients 110, 115 beyond the AP 130. In other words, the AS only allows the wireless clients 110, 115 to access to the AP 130 in order to perform authentication exchanges, or access services provided by the AP 130 that are not subject to access control restrictions placed on that port.

The AP 130 and the AS 150 may be suitably configured to exchange information using a known protocol such as RADIUS (Remote Access Dial in User Service) until the AS 150 has completed its authentication of the wireless clients 110, 115 and reported the outcome of the authentication process to both the AP 130 and the wireless clients 110, 115.

Next, the AS 150 informs the AP 130 of the outcome of the authentication request. Depending upon the outcome of the authentication process, the AS 150 communicates to the AP 130 the security policy that may be used to control the traffic from the wireless clients 110, 115. In one embodiment, the security policy are unique keys that the AP 130 and wireless client 110, 115 may use to secure communications between the AP 130 and wireless client 110, 115.

In accordance with one embodiment, the AS 150 communicates an additional client-specific key that may be suitably configured to secure the communication of management frame packets from the wireless clients 110, 115 to the AP 130.

For example, the wireless clients 110, 115 may also forward other information to the AP 130 such as management frame packets (e.g. quality-of-service (QoS) parameters) corresponding to the wireless clients 110, 115. In accordance with the present system and method, these management frame packets may be configured to include a client-specific information element (IE). This EE may be configured to contain a message authentication or integrity check (referred to as a “MIC” in the 802.11 i pre-standard and hereinafter throughout the present specification). Additionally, the EE may include a replay protection value.

It will be appreciated that the key used to generate the management frame MIC may be derived in the same manner the keys used to protect data packets or 802.1x EAPOL key messages in accordance with the 802.11 standard are derived. As well it will be appreciated that the management frame protection keys may be derived during the wireless client authentication process as described above.

Furthermore, it will be appreciated that any method or counting scheme may be used to generate a replay protection value. For example, a sequential counter initialized to zero upon authentication may be used in accordance with one embodiment. Subsequently, the replay protection value may be embedded into the IE along with the MIC and transmitted with the management frame packets.

Continuing with the example, trust relationships between wireless clients 110, 115 and the AP 130 are formed across the network channel. It will be understood that additional wireless clients (not shown) connected to the network may have a correspondingly unique message authentication check (e.g. MIC) key.

In accordance with the present system and method, received management frame packets communicated between the AP 130 and wireless clients 110, 115 may be validated by checking message digests (e.g. MIC). The message digests may be calculated by using the message authentication check key that was established during authentication.

In accordance with the present system and method, client-specific unique keys and corresponding MICs are generated to secure transmission of management information between the wireless clients 110, 115 and the AP 130. It will be appreciated that the management frame key may be derived in the same manner as the session keys referred to as the Pairwise Transient Keys (PTK) are derived as defined by the 802.11i pre-standard. Further, it will be appreciated that the key used to protect the management frame packets may be derived as an extension to the PTK derivations.

In other words, upon receipt of a management frame packet from a trusted wireless client (e.g. 110, 115), the AP 130 may be suitably configured to validate the IE prior to accepting the management frame packet. For example, the AP 130 may be suitably configured to compare the received replay protection value with locally stored or calculated values.

Additionally, the AP 130 may be suitably configured to generate a local MIC value derived from the client-specific management frame authentication key. The AP 130 may be suitably configured to compare the locally calculated MIC value with the MIC value embedded in the management frame IE received from the wireless client (e.g. 110, 115). As a result of this authentication process, the AP 130 may make a determination to process or discard the management frame.

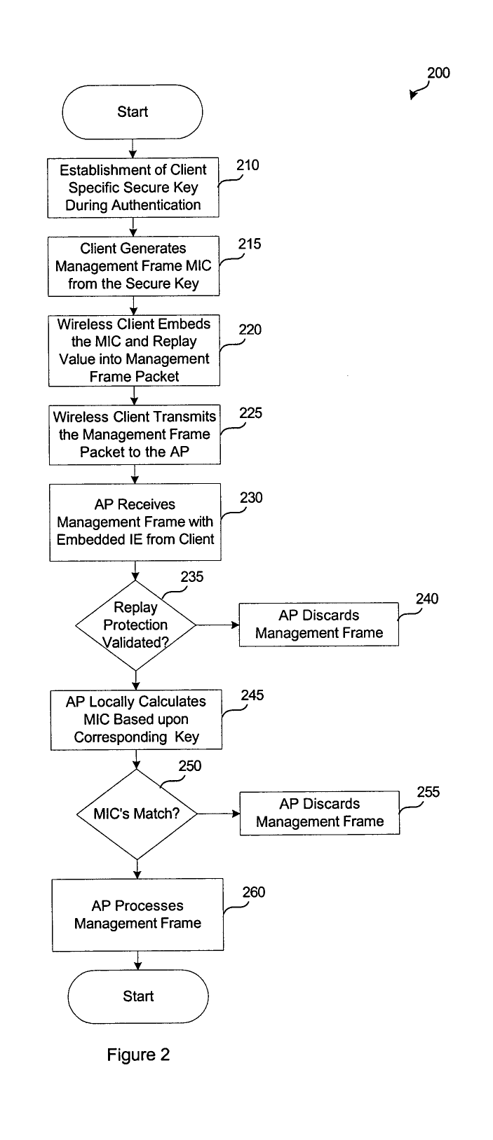

In addition, the AP 130 may be suitably configured to generate a local replay protection value. For example, the AP 130 may be configured to establish a local replay protection value from a locally administered sequence counter. This locally established replay protection value may be compared to the received replay protection value in order to verify the authentication of the transmitter. The process flow of the present and system and method may be better understood with reference to FIG. 2.

Illustrated in FIG. 2 is an embodiment of a methodology 200 associated with the present system and method. Generally, FIG. 2 illustrates the process used to establish and validate the MIC and the replay protection value transmitted together with a management frame packet via a wireless network. Furthermore, FIG. 2 presumes that the key used to generate the MIC has been established during authentication; for example, as part of the extended PTK derivation in accordance with the IEEE 802.11i pre-standard.

The illustrated elements denote “processing blocks” and represent computer software instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, does not depict syntax of any particular programming language. Rather, the diagram illustrates functional information one skilled in the art could use to fabricate circuits, generate computer software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. They may also be implemented using various programming approaches such as machine language, procedural, object oriented and/or artificial intelligence techniques. The foregoing applies to all methodologies described herein.

Referring now to FIG. 2, there is illustrated a flow chart of an embodiment of the methodology 200 for authentication and validation of a wireless client management frame transmission. The embodiment presumes the pre-establishment of a trusted relationship between all components of the system (e.g. wireless client, AP, switch, AS).

Initially, at block 210, as a result of the authentication process as described above, a client-specific secure key is established to be used for the protection of management frame transmission on the network. Next, at block 215, the wireless client locally employs the key for protecting management frames by using the key to generate a MIC to secure the transmission of the management frame packets to the AP.

An information element (IE) containing the MIC and a replay protection value is embedded within management frame packets (block 220). Once embedded, the wireless client transmits the management frame packet including the EE via the network to the AP (block 225). On the wireless side of the network, the AP receives the management frame transmission from the wireless client including the FE (block 230).

It will be appreciated that the methodology 200 illustrated in FIG. 2 describes the transmission of a single management frame packet by the wireless client.

One skilled in the art will recognize that any number of management frame transmissions may be sent during a single communication session. Accordingly, the methodology 200 of FIG. 2 as described may be applied to each individual management frame transmission.

Continuing with the embodiment, the replay protection value included in the FE is validated (decision block 235). In one example, the replay protection value may be a counter value that is initialized to zero at the time the “enhanced-PTK” is derived. It will be appreciated that the key established to protect management frames is referred to herein as the “enhanced-PTK” and may be established in accordance with the IEEE 802.11i pre-standard.

In accordance with the embodiment, at decision block 235, the counter value is verified to be a value of one greater than the previously transmitted frame. In other words, the counter value may be a sequential number generated from the zero value initiated upon the generation of the “enhanced-PTK” and increased upon the transmission of each protected management frame. Of course, it will be appreciated that any numbering or authentication scheme may be used in alternate embodiments without departing from the spirit and scope of the present invention.

If the replay counter value is not validated (e.g. does not equal the next sequential number greater than the previously received management frame), the received management frame is discarded by the AP (block 240).

If at block 235 the replay counter value is validated, the AP locally calculates a MIC based upon the corresponding unique enhanced-key for the wireless client (block 245). It will be appreciated that any desired method or hash function known in the art may be used to compute the MIC. For example, the MIC computation may be a one way hash function, such as an HMAC-SHA1 that serves as the message authentication value for the management frame.

Next, at decision block 250, the AP compares the received client MIC key with the AP locally calculated MIC to determine if the client management transmission is an authorized transmission. If at decision block 250 the received MIC does not match the locally calculated MIC, the AP discards the management frame (block 255). On the other hand, if, at decision block 255, the MIC received does match the MIC calculated by the AP, the AP consumes and processes the management frame (block 260).

While the present system has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the system, in its broader aspects, is not limited to the specific details, the representative apparatus, and illustrative examples shown and described. Accordingly, departures may be made from such details without departing from the spirit or scope of the applicant's general inventive concept.

Although the preferred embodiment has been described in detail, it should be understood that various changes, substitutions and alterations can be made therein without departing from the spirit and scope of the invention as defined by the appended claims.

1. A method for securing management frames, the method comprising the steps of:
establishing an authenticated relationship between a transmitter and a receiver on a network;
generating a key;
deriving an information element based upon the key for signing a management frame packet transmitted on the network;
embedding the information element into the management frame packet;
transmitting the management frame packet to the receiver;
receiving the management frame packet; and
validating the information element in the received management frame packet.

2. The method set forth in claim 1 wherein the information element includes a message integrity check information element.

3. The method set forth in claim 1 further comprising the steps of:
generating a replay protection value for signing the management frame packet; and
adding the replay protection value into the management frame packet prior to transmitting.

4. The method set forth in claim 3 further comprising the step of validating the replay protection value.

5. The method set forth in claim 1 wherein the step of generating a key is concurrent with the step of establishing an authenticated relationship.

6. The method set forth in claim 1 wherein the step of establishing an authenticated relationship further includes employing a key establishment protocol.

7. The method set forth in claim 1 wherein the step of validating the information element further comprises the step of comparing the information element with a locally derived information element established by the receiver.

8. The method set forth in claim 2 wherein the step of validating the information element further comprises the step of comparing the message integrity check information element of the received management frame packet with a locally derived message integrity check information element established by the receiver.

9. The method set forth in claim 3 wherein the step of validating the information element further comprises the step of comparing the replay protection value of the received management frame packet with a locally derived replay protection value established by the receiver.

10. The method set forth in claim 1 wherein the receiver includes an access point.

11. The method set forth in claim 1 wherein the transmitter includes a wireless client.

12. The method set forth in claim 2 further comprising the step of generating the message integrity check value for the management frame packet prior to transmitting.

13. A system for securing a management frame packet, the system comprising:
means for authenticating a relationship between a transmitter and a receiver;
means for generating an information element for signing the management frame packet transmitted between the transmitter and the receiver via a network;
means for adding the information element into the management frame packet;
means for transmitting the management frame packet to the receiver via the network;
means for receiving the management frame packet; and
means for validating the information element in the received management frame packet.

14. The system set forth in claim 13 wherein the information element includes a message integrity check information element.

15. The system set forth in claim 14 wherein the information element further includes a replay protection value.

16. The system set forth in claim 13 wherein the means for transmitting the management frame packet is an IEEE 802.11 protocol.

17. The system set forth in claim 13 wherein the means for adding includes means for embedding the information element into a header of the management frame packet.

18. The method set forth in claim 14, wherein the message integrity check information element uniquely identifies the management frame communication to the authenticator.

19. A method for preventing IEEE 802.11 session disruption on a network, comprising the steps of:
establishing a communication link between an access point and a wireless client on the network;
creating a trust relationship between the access point and the wireless client such that the wireless client adapted to securely access the network;
establishing a client-specific key for signing a management frame packet configured to be transmitted between the access point and the wireless client;
generating a message integrity check value based upon the client-specific key;
calculating a replay protection value for signing the management frame packet;
embedding the message integrity check value and the replay protection value into a header of the management frame packet;
transmitting the header to the access point; and
authenticating the header.

20. The method set forth in claim 19 further including the step, concurrent with the step of transmitting the header, transmitting the management frame packet.

21. The method set forth in claim 19 wherein a handshake protocol is utilized between the access point and the wireless client in the step of creating a trust relationship.

22. The method set forth in claim 19 wherein the step of authenticating further comprises the steps of:
calculating a local replay protection value;
generating a local message integrity check value;
comparing the received replay protection value with the local replay protection value; and
comparing the received message integrity check value with the local message integrity check value.

22. An article of manufacture embodied in a computer-readable medium for use in a processing system for authenticating management frame packets communicated to and/or from a network, the article comprising:
an authentication logic for causing the processing system to create a trusted relationship between a transmitter and a receiver;
a key generation logic for causing the processing system to generate a secure key for encrypting and signing an electronic management frame packet transmitted on the network;
a message integrity check generation logic for causing the processing system to generate a message integrity check for signing the electronic management frame packet transmitted on the network;
a replay protection value generation logic for causing the processing system to generate a replay protection value for signing the electronic management frame packet transmitted on the network;
a signing logic for causing the processing system to embed the message integrity check and the replay protection value into a header of the management frame packet;
a data transmitting logic for causing the processing system to transmit the header and the electronic management frame packet via the network; and
a message receiving logic for causing the processing system to verify the received message integrity check and the replay protection value included in the header.

23. The article as set forth in claim 22 wherein the data transmitting logic includes an IEEE 802.11 protocol.

24. The article as set forth in claim 22 wherein the replay protection value generation logic includes a sequential counter.

25. The article as set forth in claim 22 wherein the message receiving logic further includes logic for causing a processing system to compare a received message integrity check with a locally generated message integrity check.

26. The article as set forth in claim 22 wherein the message received logic further includes logic for causing a processing system to compare a received reply protection value with a locally calculated replay protection value.
